(19) United States
(12) Patent Application Publication
(10) Pub. No.: US 2011/0320794 A1
(43) Pub. Date: Dec. 29, 2011

(54) Flash System And Method For Updating The Flash System

(76) Inventors: Chung-Jen Yang, Taipei (TW); Ming-Jsung Huang, Taipei (TW)

(21) Appl. No.: 12/825,322

(22) Filed: Jun. 28, 2010

(51) Int. Cl. G06F 9/00; G06F 11/08

(52) U.S. Cl. 713/1

(57) ABSTRACT

A FLASH system includes two system image partitions each storing an updating program, a first boot variable partition storing a first boot variable, a second boot variable partition storing a second boot variable, and a bootloader partition storing a bootloader program. The updating program checks whether the first boot variable is valid or not, and selects which system image partition to be updated according to the first boot variable. The updating program further checks whether the FLASH system is successfully updated or not so as to report back a failure or modify the value of the first boot variable and then copy all data of the first boot variable partition to replace those of the second boot variable partition. The bootloader program checks whether the first boot variable is valid or not, and selects which system image partition to be booted according to the first boot variable.

### BACKGROUND OF THE INVENTION

1. Field of the Invention

The present invention relates to a FLASH technology, and more particularly to a FLASH system and a method for updating the FLASH system.

2. The Related Art

With the development of electronic technology, embedded devices have been widely used in various electronic products, such as wireless communication products etc. The embedded device generally includes a FLASH system for storing some corresponding programs therein. At present, the FLASH system generally includes a bootloader partition storing a bootloader program therein, a kernel partition storing a kernel program therein, and a root file system partition storing a root file system program therein. An updating program of the FLASH system will update the kernel program and the root file system program so as to do an update for the FLASH system. However, if a power failure or a failed update is happened in the process of updating the FLASH system, the kernel program and the root file system program may be destroyed to cause the FLASH system unable to be rebooted.

### SUMMARY OF THE INVENTION

An object of the present invention is to provide a FLASH system adapted to be applied in an electronic product. The FLASH system includes a first system image partition storing a first kernel program and a first root file system program therein, a second system image partition storing a second kernel program and a second root file system program therein, a first boot variable partition storing a first boot variable therein, a second boot variable partition storing a second boot variable therein, and a bootloader partition with a bootloader program stored therein. The first root file system program and the second root file system program respectively include an updating program for updating the FLASH system. The updating program can check whether the first boot variable is valid or not, and further select which of the first system image partition or the second system image partition to be updated according to the value of the first boot variable. The updating program can further check whether the FLASH system is successfully updated or not so as to report back a failure or modify the value of the first boot variable and then copy all data of the first boot variable partition to replace those of the second boot variable partition. The bootloader program can check whether the first boot variable is valid or not, and further select which of the first system image partition or the second system image partition to be booted according to the value of the first boot variable. The bootloader program copies the data of the second boot variable partition to replace those of the first boot variable partition when the first boot variable is invalid.

Another object of the present invention is to provide a method adapter for updating the foregoing FLASH system. The method includes the following steps of: (1) executing the updating program, the updating program checking whether the first boot variable is valid or not; (2) If the first boot variable is invalid, then the updating program will make the FLASH system reboot; if the first boot variable is valid, then the updating program will decide which of the first system image partition or the second system image partition will be updated according to the value of the first boot variable; (3) after one of the first and second system image partitions is updated, the updating program checking whether the FLASH system is successfully updated or not; (4) if there is a failed update for the FLASH system, then the updating program will be ended and report back the failure; if it successfully updating the FLASH system, then the updating program will modify the value of the first boot variable and copy all data of the first boot variable partition to replace those of the second boot variable partition; (5) rebooting the FLASH system, then the bootloader program checking whether the first boot variable is valid or not; (6) if the first boot variable is invalid, then the bootloader program will copy the data of the second boot variable partition to replace those of the first boot variable partition, then the step (5) will be re-executed; if the first boot variable is valid, then the bootloader program will decide which of the first system image partition or the second system image partition will be checked according to the value of the first boot variable, then the bootloader program will check whether all data of the selected system image partition are valid or not, wherein the bootloader program firstly memorizes the value of the first boot variable, then modifies the value of the first boot variable and further copies the data of the first boot variable partition to replace those of the second boot variable partition when the data of the selected system image partition are valid, the bootloader program only memorizes an operated result of the present value of the first boot variable XOR a number “1”, but do not modify the present value of the first boot variable with the operated result when the data of the selected system image partition are invalid; (7) the bootloader program deciding which of the first system image partition or the second system image partition is booted according to the value memorized by the bootloader program in the step (6); (8) after successfully booting the first system image partition or the second system image partition, the updating program rechecking whether the first boot variable is valid or not, wherein the updating program re-modifies the value of the first boot variable and then copies the data of the first boot variable partition to replace those of the second boot variable partition when the first boot variable is valid, the updating program reboots the FLASH system namely restarting from the step (5) when the first boot variable is invalid; and (9) the updating program keeping waiting till a next update demand for the FLASH system.

As described above, the FLASH system includes the first system image partition, the second system image partition, the first boot variable partition and the second boot variable partition. So if a power failure is happened in the process of updating one of the system image partitions, only the programs of the one system image partition may be destroyed. After rebooting the FLASH system, the bootloader program can execute the kernel program and the root file system program stored in the other undestroyed system image partition according to the values of the first and the second boot variables. So the FLASH system still can be booted even if the FLASH system has a failed update or the power failure in the updated process thereof.

### BRIEF DESCRIPTION OF THE DRAWINGS

The present invention will be apparent to those skilled in the art by reading the following description, with reference to the attached drawings, in which:

FIG. 1 is a block diagram of a FLASH system according to the present invention.

### DETAILED DESCRIPTION OF THE PREFERRED EMBODIMENT

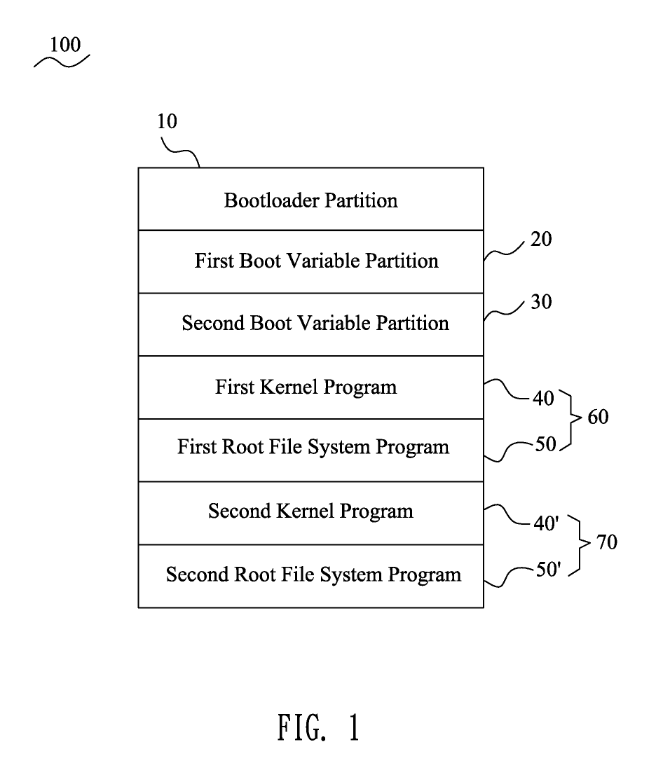

Referring to FIG. 1, a FLASH system 100 in accordance with the present invention is adapted to be applied in an electronic product. The electronic product includes a buffer capable of temporarily storing some data, and a watchdog timer for timing a boot process of the FLASH system 100. The FLASH system 100 includes a bootloader partition 10, a first boot variable partition 20, a second boot variable partition 30, a first system image partition 60 and a second system image partition 70. There are a first kernel program 40 and a first root file system program 50 stored in the first system image partition 60, and a second kernel program 40′ and a second root file system program 50′ stored in the second system image partition 70. Each of the first and second root file system program 50, 50′ includes an updating program (not shown) for timely updating the FLASH system 100. The bootloader partition 10 has a bootloader program therein. All data of any of the boot variable partitions 20, 30 and the system image partitions 60, 70 can be read to the buffer of the electronic product by the updating program and the bootloader program, and then be calculated to get a corresponding checksum. The timing process of the watchdog timer can be ended by the updating program.

The first boot variable partition 20 stores a first boot variable and a checksum therein. The second boot variable partition 30 stores a second boot variable and a checksum therein. The first and second system image partitions 60, 70 also store a checksum therein respectively. The updating program and the bootloader program can check whether the first boot variable is valid or not, by means of checking the checksum of the first boot variable partition 20 with the corresponding calculated checksum in the buffer. The updating program select which of the first system image partition 60 or the second system image partition 70 to be updated according to the value of the first boot variable. Furthermore, the updating program can check whether the first/second system image partition 60, 70 is successfully updated or not, by means of checking the checksum of the updated system image partition 60, 70 with the corresponding calculated checksum in the buffer. When there is a failed update for the FLASH system 100, the updating program reports back the failure. When the update of the FLASH system 100 has been done successfully, the updating program modifies the value of the first boot variable and then copies all data of the first boot variable partition 20 to replace those of the second boot variable partition 30. The bootloader program selects which of the first system image partition 60 or the second system image partition 70 to be booted according to the value of the first boot variable. Furthermore, the bootloader program can copy the data of the second boot variable partition 30 to replace those of the first boot variable partition 20, when the first boot variable is invalid, so that ensures the FLASH system 100 still can be booted even if the FLASH system 100 has a failed update or a power failure in the updated process thereof.

A method for updating the foregoing FLASH system will be described under the following circumstance. The circumstance is that the data of the first boot variable partition 20 are equal to those of the second boot variable partition 30, and the first boot variable and the second boot variable have an equal starting value namely “0”. The updating program and the bootloader program can always check the first boot variable partition 20 or the second boot variable partition 30. In this embodiment, the first boot variable partition 20 is always selected to be checked by the updating program and the bootloader program. The method is described hereinafter in detail under the set circumstance.

Step 1, the updating program is executed to read all data of the first boot variable partition 20 into the buffer of the electronic product and then calculate the data in the buffer to get a checksum. The updating program checks whether the calculated checksum and the stored checksum in the first boot variable partition 20 are equal or not, so as to check whether the first boot variable is valid or not. When the calculated checksum is equal to the stored checksum, the first boot variable is valid. On the contrary, the first boot variable is invalid.

Step 2, when the first boot variable is invalid, the updating program makes the FLASH system 100 reboot. When the first boot variable is valid, the updating program decides which of the first system image partition 60 or the second system image partition 70 is updated by means of executing an operation of the value of the first boot variable XOR a number “1”. When the operated result is the number “1”, the second system image partition 70 is to be updated by the updating program. When the operated result is a number “0”, the updating program makes the first system image partition 60 updated. Because the first boot variable is set to have the starting value “0”, the operated result is equal to “1” by means of “0” XOR “1”. So the second system image partition 70 will be updated by the updating program. That is to say, the second kernel program 40′, the second root file system program 50′ and the checksum stored in the second system image partition 70 will be updated.

Step 3, the updating program is executed to read all data of the second system image partition 70 into the buffer of the electronic product and then calculate the data in the buffer to get a checksum. The updating program checks whether the calculated checksum and the stored checksum in the second system image partition 70 are equal or not. When the calculated checksum is equal to the stored checksum, the update of the second system image partition 70 has been done successfully. On the contrary, there is a failed update for the second system image partition 70.

Step 4, when the failed update is happened, the updating program is ended and then reports back the failure. When successfully updating the second system image partition 70, the updating program modifies the value of the first boot variable in the first boot variable partition 20 by means of executing an operation of the value of the first boot variable XOR the number “1”. Because the first boot variable is set to have the starting value “0”, the value of the first boot variable is modified to be the number “1” by means of “0” XOR “1”. Then all data of the first boot variable partition 20 are copied to replace all data of the second boot variable partition 30. So the value of the second boot variable is also modified to be the number “1”.

Step 5, the updating program makes the FLASH system 100 reboot.

Step 6, the bootloader program in the bootloader partition 10 is executed to read all data of the first boot variable partition 20 into the buffer of the electronic product and then calculate the data in the buffer to get a checksum. The bootloader program checks whether the calculated checksum and the stored checksum in the first boot variable partition 20 are equal or not.

Step 7, if the calculated checksum is not equal to the stored checksum, then the data of the second boot variable partition 30 will be copied to replace those of the first boot variable partition 20 by the bootloader program and then the Step 6 will be re-executed so as to ensure the calculated checksum is equal to the stored checksum in the first boot variable partition 20 even if the FLASH system 100 has a failed update. If the calculated checksum is equal to the stored checksum, then the bootloader program will decide which of the first system image partition 60 or the second system image partition 70 the data will be read to the buffer of the electronic product according to the value of the first boot variable. When the FLASH system 100 is successfully updated, the first boot variable has the value “1”, so the data of the second system image partition 70 are read to the buffer of the electronic product and then calculated to get a checksum. The bootloader program checks whether the calculated checksum and the stored checksum in the second system image partition 70 are equal or not.

Step 8, if the calculated checksum is equal to the stored checksum, then the bootloader program will firstly memorize the present value of the first boot variable namely “1”, and then execute an operation of the present value of the first boot variable XOR the number “1”. That is to say, 1⊕1=0. As a result, the value of the first boot variable is modified to be “0”. Then the data of the first boot variable partition 20 are copied to replace those of the second boot variable partition 30 again. So the value of the second boot variable is also modified to be “0”. On the contrary, when the calculated checksum is not equal to the stored checksum, the bootloader program only memorizes a new value of the present value “1” of the first boot variable XOR the number “1”, namely “0”, but does not modify the value of the first boot variable.

Step 9, the bootloader program decides which of the first system image partition 60 or the second system image partition 70 is booted according to the value memorized by the bootloader program in the Step 8. When the memorized value is “1”, the second system image partition 70 is to be rooted by the bootloader program. When the memorized value is “0”, the bootloader program roots the first system image partition 60. So that ensure the FLASH system 100 still can be booted even if the FLASH system 100 has a failed update or a power failure in the updated process thereof.

Step 10, after successfully booting the second system image partition 70 or the first system image partition 60, the updating program is executed again to end the timing of the watchdog timer so as to prevent the FLASH system 100 from being rebooted again on account of long boot time of the FLASH system 100 timed by the watchdog timer. Then the updating program reads the data of the first boot variable partition 20 into the buffer of the electronic product and calculates the data in the buffer to get a checksum. The updating program checks whether the calculated checksum and the stored checksum in the first boot variable partition 20 are equal or not.

Step 11, when the calculated checksum is equal to the stored checksum, the updating program re-modifies the value of the first boot variable in the first boot variable partition 20 by means of executing an operation of the value of the first boot variable XOR the number “1”. Then all data of the first boot variable partition 20 are copied to replace those of the second boot variable partition 30. On the contrary, when the calculated checksum is not equal to the stored checksum, the updating program reboots the FLASH system 100, namely restarting from the Step 5.

Step 12, the updating program keeps waiting till a next update demand for the FLASH system 100.

In this embodiment, when the second system image partition 70 has been successfully updated, the values of the first and second boot variable are finally modified to be “1” by the updating program, so that ensures the bootloader program in the bootloader partition 10 can select the updated second system image partition 70 to be booted according to the value of the first boot variable when rebooting the FLASH system 100. Furthermore, when the next update demand occurs for the FLASH system 100, the updating program updates the old first system image partition 60 by means of the above-mentioned method because now the first and second boot variable have the values “1”. That is to say, the updating program always can update the old system image partition whenever a new update demand occurs.

As described above, the FLASH system 100 includes the first system image partition 60, the second system image partition 70, the first boot variable partition 20 and the second boot variable partition 30. So if a power failure is happened in the process of updating the second system image partition 70, only the programs of the second system image partition 70 may be destroyed. After rebooting the FLASH system 100, the bootloader program can execute the first kernel program 40 and the first root file system program 50 stored in the undestroyed first system image partition 60 according to the values of the first and the second boot variables. So the FLASH system 100 still can be booted even if the FLASH system 100 has a failed update or the power failure in the updated process thereof.

What is claimed is:

1. A FLASH system adapted to be applied in an electronic product, comprising:
a first system image partition storing a first kernel program and a first root file system program therein, the first root file system program including an updating program for updating the FLASH system;
a second system image partition storing a second kernel program and a second root file system program therein, the second foot file system program including an updating program for updating the FLASH system;
a first boot variable partition storing a first boot variable therein, the updating program capable of checking whether the first boot variable is valid or not, and further selecting which of the first system image partition or the second system image partition to be updated according to the value of the first boot variable, wherein the updating program can further check whether the FLASH system is updated or not so as to report back a failure or modify the value of the first boot variable and then copy all data of the first boot variable partition to replace those of the second boot variable partition;
a second boot variable partition storing a second boot variable therein; and
a bootloader partition with a bootloader program stored therein, the bootloader program capable of checking whether the first boot variable is valid or not, and further select which of the first system image partition or the second system image partition to be booted according to the value of the first boot variable, wherein the bootloader program copies the data of the second boot variable partition to replace those of the first boot variable partition when the first boot variable is invalid.

2. The FLASH system as claimed in claim 1, wherein the boot variable partitions and the system image partitions each store a checksum therein, the electronic product includes a buffer, all data of any of the boot variable partitions and the system image partitions can be read to the buffer by the updating program or the bootloader program and then be calculated to get a corresponding checksum, the updating program and the bootloader program check whether the first boot variable is valid or not by means of checking the checksum of the first boot variable partition with the corresponding calculated checksum in the buffer, and the updating program checks whether the FLASH system is updated or not by means of checking the checksum of the updated system image partition with the corresponding calculated checksum in the buffer.

3. The FLASH system as claimed in claim 1, wherein the electronic product includes a watchdog timer for timing a boot process of the FLASH system, the updating program can end the timing process of the watchdog timer after the FLASH system is booted.

4. A method adapted for updating the foregoing FLASH system, comprising the steps of:
(1) executing the updating program, the updating program checking whether the first boot variable is valid or not;
(2) if the first boot variable is invalid, then the updating program will make the FLASH system reboot; if the first boot variable is valid, then the updating program will decide which of the first system image partition or the second system image partition will be updated according to the value of the first boot variable;
(3) after one of the first and second system image partitions is updated, the updating program checking whether the FLASH system is updated or not;
(4) if there is a failed update for the FLASH system, then the updating program will be ended and then report back the failure; if it updates the FLASH system, then the updating program will modify the value of the first boot variable and copy all data of the first boot variable partition to replace those of the second boot variable partition;
(5) rebooting the FLASH system, then the bootloader program checking whether the first boot variable is valid or not;
(6) if the first boot variable is invalid, then the bootloader program will copy the data of the second boot variable partition to replace those of the first boot variable partition, then the step (5) will be re-executed; if the first boot variable is valid, then the bootloader program will decide which of the first system image partition or the second system image partition will be checked according to the value of the first boot variable, then the bootloader program will check whether all data of the selected system image partition are valid or not, wherein the bootloader program firstly memorizes the value of the first boot variable, then modifies the value of the first boot variable and further copies the data of the first boot variable partition to replace those of the second boot variable partition when the data of the selected system image partition are valid, the bootloader program only memorizes an operated result of the present value of the first boot variable XOR a number “1”, but do not modify the present value of the first boot variable with the operated result when the data of the selected system image partition are invalid;
(7) the bootloader program deciding which of the first system image partition or the second system image partition is booted according to the value memorized by the bootloader program in the step (6);
(8) after booting the first system image partition or the second system image partition, the updating program rechecking whether the first boot variable is valid or not, wherein the updating program re-modifies the value of the first boot variable and then copies the data of the first boot variable partition to replace those of the second boot variable partition when the first boot variable is valid, the updating program reboots the FLASH system namely restarting from the step (5) when the first boot variable is invalid; and
(9) the updating program keeping waiting till a next update demand for the FLASH system.

5. The method as claimed in claim 4, wherein the updating program and the bootloader program check whether the first boot variable is valid or not in the steps (1), (5) and (8) by means of reading all data of the first boot variable partition into the buffer of the electronic product, then calculating the data in the buffer to get a checksum, and lastly checking whether the calculated checksum and the stored checksum in the first boot variable partition are equal or not.

6. The method as claimed in claim 4, wherein the updating program and the bootloader program check whether the data of the first/second system image partition are valid or not in the steps (3) and (6) by means of reading all data of the first/second system image partition into the buffer of the electronic product, then calculating the data in the buffer to get a checksum, and lastly checking whether the calculated checksum and the stored checksum in the first/second system image partition are equal or not.

7. The method as claimed in claim 4, wherein the updating program and the bootloader program modify the value of the first boot variable in the steps (4), (6) and (8) by means of executing an operation of the value of the first boot variable XOR a number “1”.

8. The method as claimed in claim 4, wherein the updating program decides which of the first system image partition or the second system image partition is updated in the step (2) according to an operated result of the value of the first boot variable XOR a number “1”.

9. The method as claimed in claim 4, wherein the updating program is firstly executed to end the timing of the watchdog timer before the updating program checks whether the first boot variable is valid or not in the step (8).
